(19) United States
(12) Patent Application Publication
(10) Pub. No.: US 2016/0229293 A1
(43) Pub. Date: Aug. 11, 2016

(54) ELECTRICALLY DRIVEN VEHICLE

(71) Applicant: TOYOTA JIDOSHA KABUSHIKI KAISHA, Toyota-shi, Aichi-ken (JP)

(72) Inventors: Yusuke SEO, Kasugai-shi (JP); Hiroto KUSAKA, Toyota-shi (JP)

(73) Assignee: TOYOTA JIDOSHA KABUSHIKI KAISHA, Toyota-shi, Aichi-ken (JP)

(21) Appl. No.: 15/021,821

(22) PCT Filed: Sep. 17, 2014
(86) PCT No.: PCT/IB2014/001856

§ 371 Date: Mar. 14, 2016

(30) Foreign Application Priority Data
Sep. 19, 2013 (JP) 2013-194009

(51) Int. Cl. B60L 1/00; H02P 27/06; B60K 6/26; B60L 11/18; B60K 6/52

(52) U.S. Cl. CPC B60L 1/003; B60L 11/1803; B60K 6/52; B60K 6/26; H02P 27/06; B60L 2260/28; Y10S 903/951; Y10S 903/906; B60Y 2200/92; B60Y 2200/91; B60Y 2400/82; B60Y 2400/604; B60Y 2400/61

(57) ABSTRACT

An electrically driven vehicle includes a battery, front and rear motors, front and rear inverters, and a distributor. The front motor and the front inverter are arranged in a front region of the vehicle. The front inverter is configured to convert battery electric power into an alternating-current electric power, and supply the alternating-current electric power to the front motor. The rear motor and the rear inverter are arranged in a rear region of the vehicle. The rear inverter is configured to convert battery electric power into an alternating-current electric power, and supply the alternating-current electric power to the rear motor. The distributor is configured to distribute the electric power of the battery to the front inverter and the rear inverter. One of the rear inverter and another device that is attached to and removed from the vehicle together with the rear inverter is provided with the distributor.

### BACKGROUND OF THE INVENTION

1. Field of the Invention invention relates to an electrically driven vehicle. “The electrically driven vehicle” in the present specification includes a hybrid vehicle that is equipped with both a motor and an engine, and a fuel cell vehicle.

2. Description of Related Art

Four-wheel-drive electrically driven vehicles that are equipped with motors in front and rear regions thereof have been studied. For example, Japanese Patent Application Publication No. 2005-323455 (JP-2005-323455 A) discloses an electrically driven vehicle that is mounted with a hybrid system, which is equipped with an engine and a motor as drive sources for front wheels, in a vehicle front region. And the electrically driven vehicle is mounted with another motor as a drive source for rear wheels in a vehicle rear region. “The vehicle front region” means a front side with respect to the position of a center of gravity of the vehicle in a longitudinal direction of the vehicle, or a front side with respect to a center in the longitudinal direction of the vehicle. By the same token, “the vehicle rear region” means a rear side with respect to the position of the center of gravity of the vehicle in the longitudinal direction of the vehicle, or a rear side with respect to the center in the longitudinal direction of the vehicle.

As one mode of a four-wheel-drive electrically driven vehicle, there may be a mode in which one of the drive sources for the front and rear wheels is used for normal running, and the other is supplementarily used in specific cases. Typically, there is a mode in which the vehicle usually runs with two wheels driven, and a switchover to four-wheel drive is made when running on a snowy road. Alternatively, there may be a mode in which four-wheel drive is adopted only when a large acceleration is required. In other words, such a four-wheel-drive electrically driven vehicle has a vehicle concept in which one of the drive sources for the front and rear wheels is regarded as a main drive source, and the other is regarded as an auxiliary drive source. If such a concept is assumed, it is preferable that the auxiliary drive source be able to be fitted at relatively low cost as an option for the two-wheel-drive vehicle. Then, vehicle manufacturers can increase the number of vehicle variations at low cost. For example, for the same type of vehicle, a two-wheel-drive vehicle and a four-wheel-drive vehicle modified as a specification for cold places or a specification for high output can be realized at low cost. The present specification provides an art capable of turning a two-wheel-drive system into a four-wheel-drive system through minimum required alterations. That is, the present specification provides an art capable of changing a two-wheel-drive electrically driven vehicle into a four-wheel-drive electrically driven vehicle at low cost.

Incidentally, the aforementioned “auxiliary” drive source is meant to be a drive source that is not used during normal running, but is used in specific cases (e.g., when running on a snowy road, when running on a slope, or when a large acceleration is required). In the present specification, the word “auxiliary” includes the meaning of the word “temporarily”.

### SUMMARY OF THE INVENTION

An electrically driven vehicle according to a first aspect of the invention is equipped with a battery, a front motor, a front inverter, a rear motor, a rear inverter, and a distributor. The front motor is arranged in a front region of the vehicle. The front motor is configured to drive front wheels. The front inverter is arranged in the front region of the vehicle. The front inverter is configured to convert an electric power of the battery into an alternating-current electric power and supply the alternating-current electric power to the front motor. The rear motor is arranged in a rear region of the vehicle. The rear motor is configured to drive rear wheels. The rear inverter is arranged in the rear region of the vehicle. The rear inverter is configured to convert an electric power of the battery into an alternating-current electric power and supply the alternating-current electric power to the rear motor. The distributor is configured to distribute the electric power of the battery to the front inverter and the rear inverter. One of the rear inverter and another device that is attached to and removed from the vehicle together with the rear inverter is provided with the distributor.

An electrically driven vehicle according to a second aspect of the invention is equipped with a battery, a front motor, a front inverter, a rear motor, a rear inverter, and a distributor. The front motor is arranged in a front region of the vehicle. The front motor is configured to drive front wheels. The front inverter is arranged in the front region of the vehicle. The front inverter is configured to convert an electric power of the battery into an alternating-current electric power and supply the alternating-current electric power to the front motor. The rear motor is arranged in a rear region of the vehicle. The rear motor is configured to drive rear wheels. The rear inverter is arranged in the rear region of the vehicle. The rear inverter is configured to convert an electric power of the battery into an alternating-current electric power and supply the alternating-current electric power to the rear motor. The distributor distributes the electric power of the battery to the front inverter and the rear inverter. One of the front inverter and another device that is attached to and removed from the vehicle together with the front inverter is provided with the distributor.

According to the aforementioned configurations, a two-wheel-drive electrically driven vehicle can be changed into a four-wheel-drive electrically driven vehicle at low cost.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1A is a schematic layout diagram of an inverter and a battery at the time when a front-wheel-drive electrically driven vehicle is viewed laterally;

FIG. 1B is a schematic layout diagram of the inverter and the battery at the time when the front-wheel-drive electrically driven vehicle is viewed from above;

FIG. 2A is a schematic layout diagram of an inverter and a battery at the time when an electrically driven vehicle according to the first embodiment of the invention is viewed laterally;

FIG. 2B is a schematic layout diagram of the inverter and the battery at the time when the electrically driven vehicle according to the first embodiment of the invention is viewed from above;

FIG. 3 is a schematic block diagram of a drive system of the electrically driven vehicle according to the first embodiment of the invention;

FIG. 4A is a schematic layout diagram of an inverter and a battery at the time when an electrically driven vehicle according to the second embodiment of the invention is viewed laterally;

FIG. 4B is a schematic layout diagram of the inverter and the battery at the time when the electrically driven vehicle according to the second embodiment of the invention is viewed from above;

FIG. 5A is a schematic layout diagram of an inverter and a battery at the time when an electrically driven vehicle according to the third embodiment of the invention is viewed laterally;

FIG. 5B is a schematic layout diagram of the inverter and the battery at the time when the electrically driven vehicle according to the third embodiment of the invention is viewed from above;

FIG. 6A is a schematic layout diagram of an inverter and a battery at the time when an electrically driven vehicle according to the fourth embodiment of the invention is viewed laterally;

FIG. 6B is a schematic layout diagram of the inverter and the battery at the time when the electrically driven vehicle according to the fourth embodiment of the invention is viewed from above;

FIG. 7 is a plan view showing an example of the structure of a distributor (with no cover); and

FIG. 8 is a plan view showing another example of the structure of a distributor (with no cover).

### DETAILED DESCRIPTION OF EMBODIMENTS

In many cases, an inverter is arranged close to a motor. This is because the loss in an electric power transmission path should be reduced by shortening the length of a power cable between the inverter and the motor. For example, in a front-wheel-drive electrically driven vehicle, the motor and the inverter are mounted in a front region of the vehicle, and a battery and the inverter are connected to each other by a power cable. In the case where such a two-wheel-drive electrically driven vehicle is changed into a four-wheel-drive electrically driven vehicle, another motor and another inverter are needed to be mounted in a rear region of the vehicle. In this case, an electric power supply path from the battery to the inverter needs to be changed from an existing path. The change is considered to have the following three modes. In the first mode, the electric power supply path from the battery to the inverter in the front region of the vehicle (a front inverter) is left untouched, and an electric power supply path from the battery to the inverter in the rear region of the vehicle (a rear inverter) is newly added. In the second mode, the front inverter is newly provided with an electric power distributor (hereinafter referred to as distributor), and an electric power supply path from the distributor to the rear inverter needs to be newly added. In the third mode, the newly mounted rear inverter is provided with an electric power distributor (hereinafter referred to as distributor), and an electric power supply path from the battery to the respective front and rear inverters through the distributor is newly provided.

In the aforementioned first and second modes, the electric power supply path of a drive source with which the vehicle is originally equipped is utilized. Therefore, one of the first and second modes seems to be the lowest in cost. However, in the first mode, a connection terminal of the front inverter to which a power cable leading to the battery is attached needs to be changed. Furthermore, in the second mode, a power cable connection terminal of the battery needs to be changed. That is, in both the first and second modes, an existing device needs to be changed. In contrast, in the third mode, from the standpoint of the battery, it is necessary only to switch over a connection destination of the power cable extending from the terminal of the battery to the distributor with which the rear inverter is equipped. From the standpoint of the front inverter, it is necessary only to switch over a connection destination of the power cable extending from the front inverter to the aforementioned distributor. That is, there is no need to change the existing battery and the front inverter at all. Besides, the distributor can also be mounted together with the rear inverter. Therefore, the operation of mounting the distributor itself is not required. In this manner, the two-wheel-drive vehicle can be changed into the four-wheel-drive vehicle at low cost by mounting the rear inverter or another device that is attached/removed to/from the rear inverter at the same time, with the distributor.

In the following, the motor and the inverter for driving front wheels will be referred to as a front motor and a front inverter respectively, and the motor and the inverter for driving rear wheels will be referred to as a rear motor and a rear inverter respectively. Besides, the battery is typically arranged between the front inverter and the rear inverter. More specifically, the battery is often arranged below a rear seat, in a rear region (in front of a rear compartment), or below a front seat. Besides, the battery may also be arranged between right and left front seats.

One feature of the electrically driven vehicle disclosed by the present specification consists in that the rear inverter or another device that is attached/removed to/from the vehicle together with the rear inverter is provided with a distributor that distributes the electric power of the battery to the respective inverters. The distributor may be provided inside a housing of the rear inverter, or may be attached to an outside of the housing. Alternatively, the distributor may be attached to the rear motor that is combined with the rear inverter. In this case, the rear motor is equivalent to an example of “another device that is attached/removed simultaneously with the rear inverter” as mentioned above. In any case, the distributor can also be attached to the vehicle at the same time by performing an operation of attaching the rear inverter. Therefore, the efficiency of the operation of making a shift to the four-wheel-drive vehicle is high. The rear motor is a typical example of “another device” as mentioned above. However, “another device” may not necessarily be this rear motor. For example, in the same manner as the rear motor and the rear inverter are optional, “another device” may be another voltage converter that is optionally mounted adjacently to the rear inverter.

In the case where the rear motor is an optional drive source, the rear motor is an auxiliary drive source that supplements the driving force of the front motor that is used for normal running, as described above. In this case, a motor whose maximum output is smaller than that of the front motor is adopted as the rear motor. In other words, the rear motor is an auxiliary drive source, and is a drive source that is less frequently used than the front motor. It should be noted herein that it is determined whether “the frequency of use” is high or low depending not only on whether the frequency with which the drive source is used is high or low but also on whether the sum of the electric power output from the inverter is large or small or the like, for example, in the case where the vehicle is caused to run at a constant speed. That is, the front inverter may be an inverter that is mainly used when the vehicle runs, and the rear inverter may be an inverter that is supplementarily used.

Incidentally, in the aforementioned aspect of the invention, there is assumed a case where the front motor is a main drive source and the rear motor is an auxiliary drive source (an optional drive source). However, the roles of the front motor and the rear motor may be reversed. That is, in the case where the front motor is an auxiliary drive source, the front inverter or another device that is attached/removed to/from the vehicle together with the front inverter may be provided with the distributor that distributes the electric power of the battery to the respective inverters.

The features other than those mentioned above will be described. Incidentally, the technical elements mentioned below are technical elements that are independent of one another, and are technically useful alone or in various combinations. These technical elements should not be limited to the combination set forth in the claims at the time of the filing of the application.

In the case where the rear motor is an auxiliary drive source, a fuse may be provided in an electric power supply path between the distributor and the rear inverter. Even if an inconvenience is caused in the rear motor or the rear inverter for some reason, the fuse is cut off, so the rear inverter can be detached from the electric power supply path between the battery and the front inverter. In that case, the vehicle can continue to run only by the front drive source regardless of the state of the rear drive source.

In the case where the front motor is a main drive source, the front inverter is equipped with a step-up circuit that steps up the voltage of the battery, and an inverter circuit that converts the output of the step-up circuit into an alternating current. On the other hand, the rear inverter may adopt a configuration in which the rear motor is auxiliary and therefore has only an inverter circuit without having a step-up circuit. In other words, the input/output voltage of the rear inverter is equal to the voltage of the battery. In such a case, the front inverter has a step-up circuit, so the influence of high-frequency noise of the inverter circuit on the battery is small. In the rear inverter, however, the battery and the inverter circuit are directly coupled to each other, so the influence of high-frequency noise on the battery may be great. In order to suppress the influence of high-frequency noise of the rear inverter, a choke coil may be provided in the electric power supply path between the distributor and the rear inverter.

The battery may be arranged between the front inverter and the rear inverter in the longitudinal direction of the vehicle.

The length of the power cable that is connected to the terminal of the battery and the terminal of the distributor may be shorter than the length of the power cable that is connected to the terminal of the distributor and the terminal of the front inverter.

The distance between the battery and the rear inverter in the longitudinal direction of the vehicle may be shorter than the distance between the battery and the front inverter in the longitudinal direction of the vehicle.

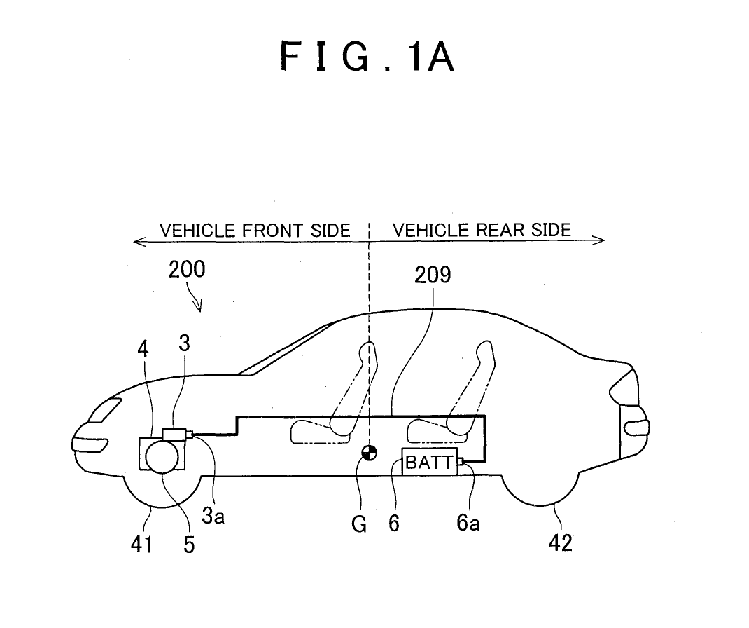

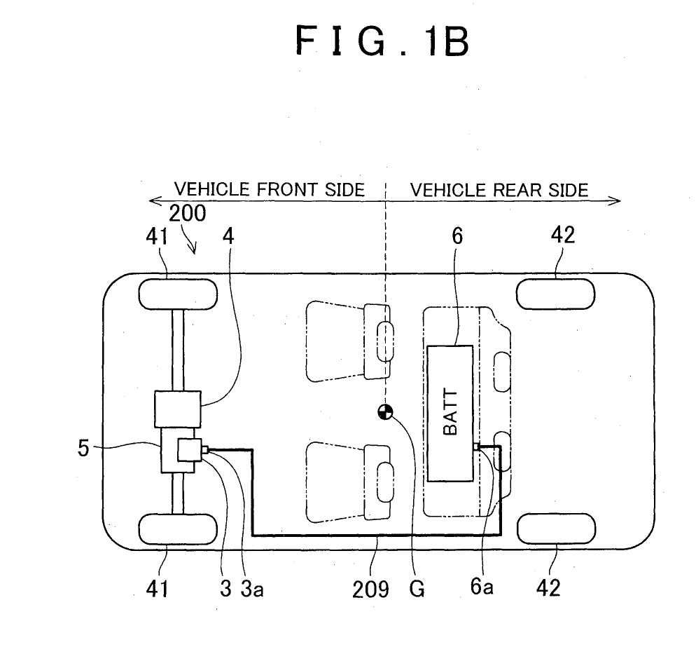

The layout of a motor, an inverter, and a battery of an electrically driven vehicle (a hybrid vehicle 200) whose two front wheels are driven will be described. FIG. 1A is a schematic layout diagram of a front motor, a front inverter, and a battery at the time when the hybrid vehicle 200 is viewed laterally. FIG. 1B is a schematic layout diagram (a planar layout diagram) at the time when the hybrid vehicle 200 is viewed from above. In the drawings, front seats and a rear seat are depicted by virtual lines.

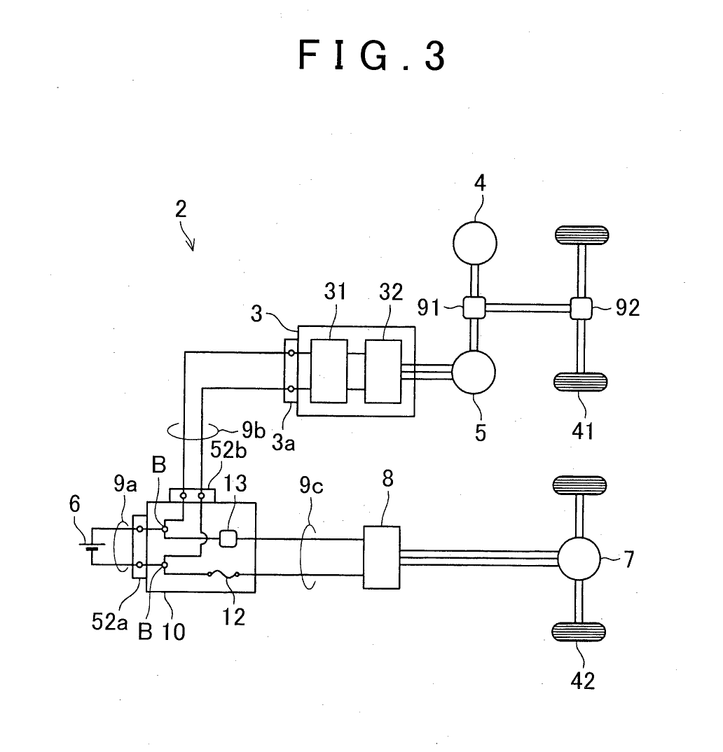

In the hybrid vehicle 200, two front wheels are driven, and an engine 4, a front motor 5, and a front inverter 3 are arranged in a front compartment in a front region of the vehicle. Outputs of the engine 4 and the front motor 5 are transmitted to front wheels 41. The transmission path will be described later with reference to FIG. 3. The front inverter 3 is fixed to a housing of the front motor 5. This is because the loss in electric power transmission should be suppressed by shortening the distance between the inverter and the motor as described above.

A battery 6 that stores an electric power for driving the front motor 5 is arranged below the rear seat. The battery 6 and the front inverter 3 are connected to each other by a power cable 209. The power cable 209 is equivalent to an electric power supply path (an electric power transmission path) that transmits the electric power of the battery 6 to the front inverter 3. The power cable 209 electrically connects a terminal 6a of the battery 6 and a terminal 3a of the front inverter 3 to each other. In each of FIG. 1 and the following drawings, power cables that supply an electric power from the battery to the inverter are depicted by thick lines. Rear wheels are denoted by a reference numeral 42. In the hybrid vehicle 200, the rear wheels 42 are driven wheels that do not have a driving force.

In FIGS. 1A and 1B, the position of a center of gravity of the vehicle is denoted by a reference symbol G. A region in front of the position G of the center of gravity is equivalent to a front region of the vehicle (a vehicle front region), and a region behind the position G of the center of gravity is equivalent to a rear region of the vehicle (a vehicle rear region). The same holds true for the following drawings.

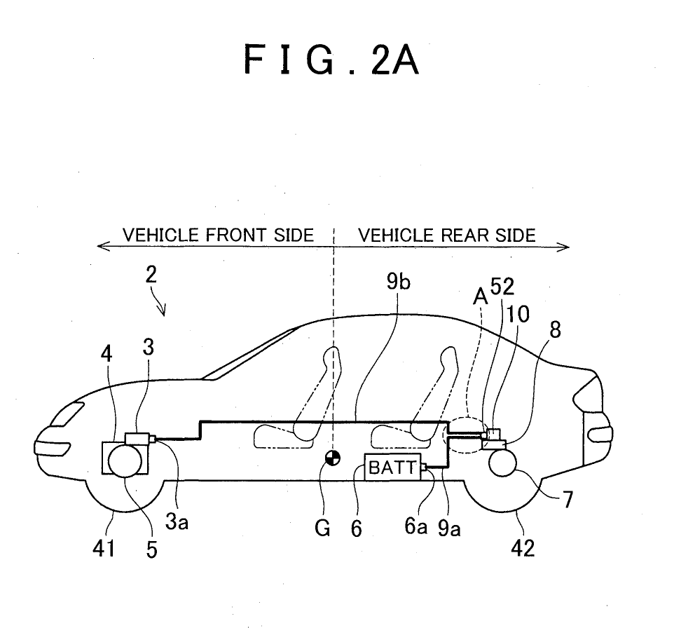

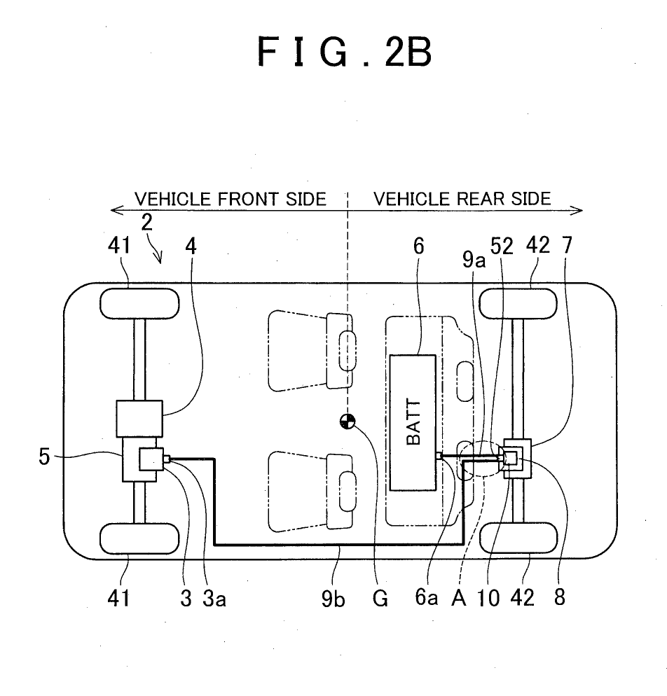

Next, the layout of a battery, motors and inverters in the electrically driven vehicle (a hybrid vehicle 2) according to the first embodiment of the invention will be described with reference to FIGS. 2A and 2B. The hybrid vehicle 2 is obtained by adding a rear motor 7 and a rear inverter 8 for driving rear wheels to the two-wheel-drive hybrid vehicle 200 of FIGS. 1A and 1B. Accordingly, the engine 4, the front motor 5 and the front inverter 3 are arranged in the same manner as in FIGS. 1A and 1B. However, the wiring of power cables is different from that of FIGS. 1A and 1B.

The rear motor 7 and the rear inverter 8 are installed in the vehicle rear region. “The vehicle rear region” includes, for example, a region behind the vehicle with respect to the position G of the center of gravity of the vehicle in the longitudinal direction of the vehicle. The rear motor 7 is an auxiliary drive source, and has a smaller output than the front motor 5 as a main drive source. For example, the maximum output of the front motor 5 is 50 kW, and the maximum output of the rear motor 7 is 5 kW. The hybrid vehicle 2 usually runs by the engine 4 and the front motor 5, and supplementarily drives the rear motor 7 according to need. For example, when the vehicle tends to slip on a snowy road, the rear motor 7 is driven to cause the vehicle to run with its four wheels driven. Alternatively, the rear motor 7 is driven to provide torque assistance at the time of hill start. The rear motor 7 and the rear inverter 8 are attached, as optional equipment of the two-wheel-drive hybrid vehicle 200, in accordance with the request made by a user.

As is the case with the front inverter 3, the rear inverter 8 is also fixed to a housing of the rear motor 7. This is because the loss in electric power transmission between the rear inverter 8 and the rear motor 7 can be suppressed by shortening the distance between the rear inverter 8 and the rear motor 7. The rear inverter 8 may be fixed onto a floor panel instead of being attached to the rear motor 7.

Referring to FIGS. 1A and 1B and FIGS. 2A and 2B, the two-wheel-drive hybrid vehicle 200 and the four-wheel-drive hybrid vehicle 2 are different from each other in the wiring of the electric power supply paths from the battery 6 to the inverter, namely, the power cables. In the hybrid vehicle 2, a power cable 9a that extends from the battery 6 is connected to a distributor 10. To be more precise, the power cable 9a connects the terminal 6a of the battery 6 and a terminal 52 of the distributor 10 to each other. The distributor 10 distributes an output electric power of the battery 6 to the rear inverter 8 and the front inverter 3. The distributor 10 is attached to a housing of the rear inverter 8. Since the distributor 10 is fixed to the housing of the rear inverter 8, the power cable from the distributor 10 to the rear inverter 8 passes the interiors of the distributor 10 and the rear inverter 8, and is not visible in FIGS. 2A and 2B.

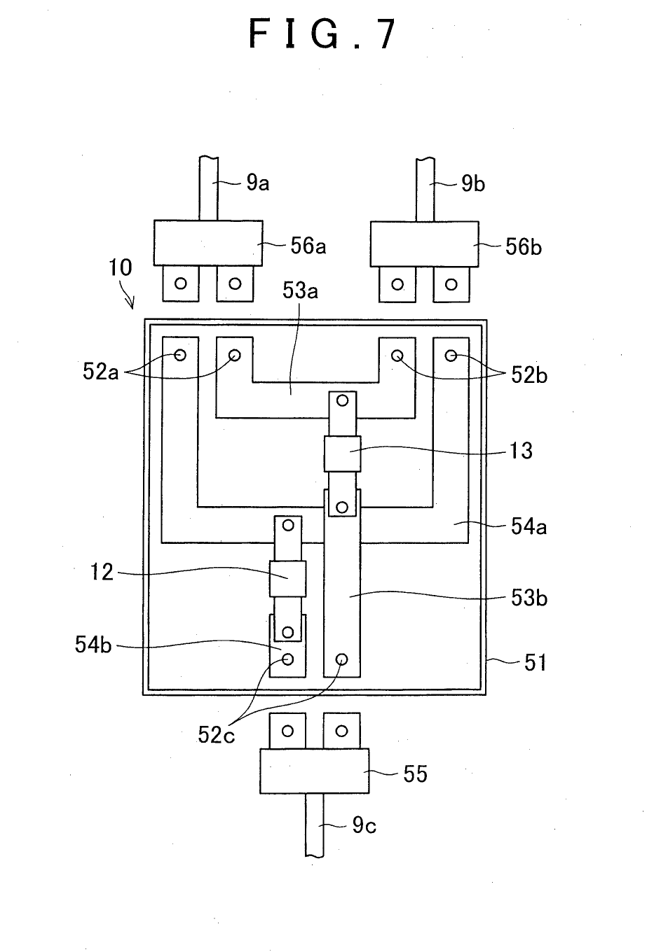

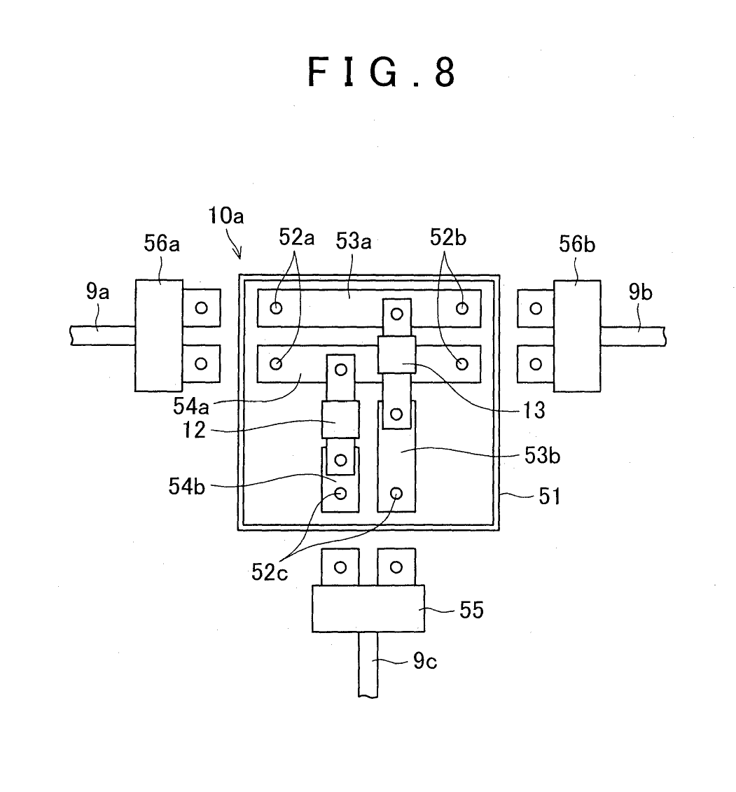

The distributor 10 and the front inverter 3 are connected to each other by a power cable 9b. To be more precise, the power cable 9b connects the terminal 3a of the front inverter 3 and the terminal 52 of the distributor 10 to each other. In FIGS. 2A and 2B, two terminals of the distributor are depicted in a simplified manner as a single terminal. The connection of the power cables will be described later in detail with reference to FIGS. 7 and 8. The electric power from the battery 6 is first transmitted to the distributor 10 in the rear region of the vehicle. In the case where the rear motor 7 is driven, the electric power of the battery 6 bifurcates in the distributor 10, and is supplied to the rear inverter 8 and the front inverter 3. As is apparent from FIGS. 1A and 1B and FIGS. 2A and 2B, the electric power supply path of the two-wheel-drive hybrid vehicle 200 with its front wheels driven and the electric power supply path of the four-wheel-drive hybrid vehicle 2 are different from each other only in the range indicated by a reference symbol A in FIGS. 2A and 2B, and are identical to each other in other respects. This means, namely, that there is no need to change the terminal 6a of the battery 6 and the terminal 3a of the front inverter 3 at all in making a shift to the four-wheel-drive vehicle by attaching the rear motor 7 and the rear inverter 8 to the two-wheel-drive hybrid vehicle 200. Furthermore, it is sufficient to change the wiring of the power cables only in the range denoted by the reference symbol A, and the required change in the wiring of the power cables in the two-wheel-drive hybrid vehicle 200 is also minimized.

Besides, the distributor 10 is attached to the housing of the rear inverter 8. As is apparent from the foregoing structure, the operation of making a shift from the two-wheel-drive hybrid vehicle 200 with its front wheels driven to the four-wheel-drive vehicle is performed simply by mounting the vehicle with an assembly of the rear motor 7, the rear inverter 8 and the distributor 10 and replacing the power cables. Moreover, the hybrid vehicle 200 and the hybrid vehicle 2 are identical to each other in most of the wiring paths of the power cables. The hybrid vehicle 2 according to the first embodiment of the invention can be changed from a two-wheel-drive configuration to a four-wheel-drive configuration at low cost.

The drive system of the hybrid vehicle 2 will be described with reference to FIG. 3. The battery 6 is connected to the distributor 10 by the power cable 9a. The power cable 9a that extends from the battery 6 is connected to a first terminal 52a of the distributor 10. The electric power supply path is divided into two electric power supply paths inside the distributor 10. One of the electric power supply paths is the power cable 9b through which an electric power is supplied to the front inverter 3, and the other is a power cable 9c through which an electric power is supplied to the rear inverter 8. The power cable 9b is connected to a second terminal 52b of the distributor 10 and the terminal 3a of the front inverter 3. Incidentally, since the distributor 10 is attached to the housing of the rear inverter 8, the power cable 9c is invisible in FIGS. 2A and 2B.

A fuse 12 and a choke coil 13 are connected to an electric power supply path between an electric power bifurcation point B in the distributor 10 and the rear inverter 8. The choke coil 13 is inserted to reduce the influence exerted on the battery 6 by switching noise of the inverter 8. Besides, in the case where an overcurrent has flowed through the rear inverter 8, the fuse 12 is cut off. Due to the cutoff of the fuse 12, the rear inverter 8 is detached from the electric power supply path from the battery 6 to the front inverter 3. By detaching the rear inverter 8, the vehicle can continue to run by the battery 6 and the front inverter 3 even when an inconvenience is caused in the rear inverter 8.

The drive voltage of the front motor 5 is higher than the output voltage of the battery 6. Therefore, the front inverter 3 has a step-up circuit 31 and an inverter circuit 32. In other words, the front inverter 3 is equipped with the step-up circuit 31 between the inverter circuit 32 and the battery 6. The step-up circuit 31 includes a reactor, and can reduce the influence exerted on the battery 6 by switching noise of the inverter circuit 32, through the use of the reactor. On the other hand, the rear inverter 8 is not equipped with a step-up circuit, so the choke coil 13 is inserted in the electric power supply path between the rear inverter 8 and the battery 6. The choke coil 13 reduces the influence exerted on the battery 6 by switching noise of the rear inverter 8.

The front inverter 3 is supplied with an electric power from the battery 6 via the distributor 10, and converts the electric power of the battery 6 into an alternating-current electric power, and supplies the alternating-current electric power to the front motor 5. The front motor 5 operates upon being supplied with an electric power from the front inverter 3. An output torque of the front motor 5 and an output torque of the engine 4 are synthesized with each other by a motive power distribution mechanism 91, and are transmitted to the front wheels 41 via a differential 92. Incidentally, the motive power distribution mechanism 91 also distributes the output torque of the engine 4 to the front wheels 41 and the front motor 5 in some cases. In such cases, the hybrid vehicle 2 generates an electric power by the front motor 5 while running by the motive power of the engine 4. The battery 6 is charged with the generated electric power.

The rear inverter 8 is mounted on the rear motor 7. In a rear drive system, the rear inverter 8 is supplied with an electric power from the battery 6 via the distributor 10, converts the electric power of the battery 6 into an alternating-current electric power, and supplies the alternating-current electric power to the rear motor 7. As described above, the output of the rear motor 7 is smaller than the output of the front motor 5, and the rated voltage of the rear motor 7 is equal to the output voltage of the battery 6. Therefore, the rear inverter 8 does not have a step-up circuit. The rear motor 7 operates upon receiving an alternating current of the same voltage as of the battery 6, from the rear inverter 8. A driving force of the rear motor 7 is directly transmitted to the rear wheels 42. The rear inverter 8, the rear motor 7, and the distributor 10 are coupled to one another to constitute a single unit. The rear inverter 8 and the distributor 10 may be connected to each other and mounted separately from the rear motor 7. In this case as well, the operation of change can be facilitated.

As described above, the hybrid vehicle 2 can be additionally equipped later with the rear motor 7, the rear inverter 8, and the distributor 10 as optional equipment. Those devices also facilitate the operation of changing the power cables that connect the battery and the inverters to one another. The hybrid vehicle 2 according to the first embodiment of the invention can be changed from a two-wheel-drive configuration to a four-wheel-drive configuration at low cost. In particular, if the battery is provided with the distributor that distributes an electric power to the respective inverters when changing a two-wheel-drive vehicle into a four-wheel-drive vehicle, a battery for two-wheel drive and a battery for four-wheel-drive need to be prepared, so the manufacturing cost rises substantially. Thus, in the present embodiment of the invention, the rear inverter that is mounted on the two-wheel-drive vehicle is provided with the distributor that distributes an electric power, so a shift to the four-wheel-drive vehicle can be made at low cost while diverting an existing system of the two-wheel-drive vehicle.

Other features of the hybrid vehicle 2 will be described. The battery 6 is mounted below the rear seat. In other words, the battery 6 is arranged between the front inverter 3 and the rear inverter 8 in the longitudinal direction of the vehicle. The longitudinal direction of the vehicle is shown in the drawings. It should be noted herein that a space “between the front inverter 3 and the rear inverter 8” may be a space between a front-wheel axle and a rear-wheel axle, or a space onto which a passenger compartment is projected in a vehicle plan view of FIG. 2B. Besides, as is apparent from FIGS. 2A and 2B, the battery 6 is close to the rear inverter 8. Then, the distance between the battery 6 and the rear inverter 8 in the longitudinal direction of the vehicle is shorter than the distance between the battery 6 and the front inverter 3 in the longitudinal direction of the vehicle. This is advantageous in that the power cable 9a between the battery 6 and the distributor 10 can be shortened. Besides, the distance between the battery 6 and the rear inverter 8 in the longitudinal direction of the vehicle includes the length of the power cable 9a between the output terminal 6a (an output connector portion) of the battery 6 to the rear inverter 8 and an input terminal (an input connector portion) of the rear inverter 8. Besides, the battery 6 is arranged behind the front inverter 3 in the longitudinal direction of the vehicle in a vehicle lateral view of FIG. 2A, so the power cable 9a from the battery 6 to the distributor 10 attached to the rear inverter 8 can be made shorter than the power cable 9b from the distributor 10 attached to the rear inverter 8 to the front inverter 3. A total of electric power consumption of the two inverters flows from the battery 6 to the distributor 10. Therefore, the loss in electric power transmission can be reduced as the wiring distance of the power cable (the length of the cable) from the battery 6 to the distributor 10 decreases. Besides, the battery 6 and the rear inverter 8 are arranged close to each other. The word “close” also includes a case where the battery 6 and the rear inverter 8 are arranged behind the position G of the center of gravity of the vehicle with respect to the vehicle. For example, the battery 6 may be arranged below the rear seat, and the rear inverter may be arranged in a luggage space.

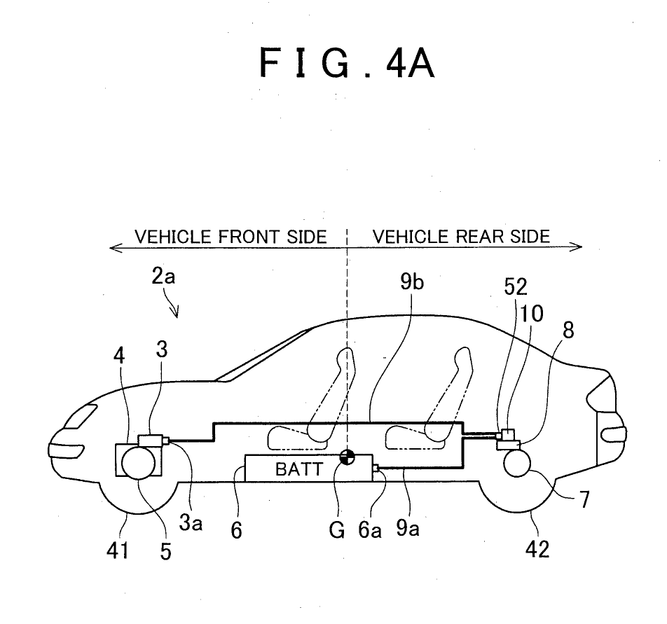

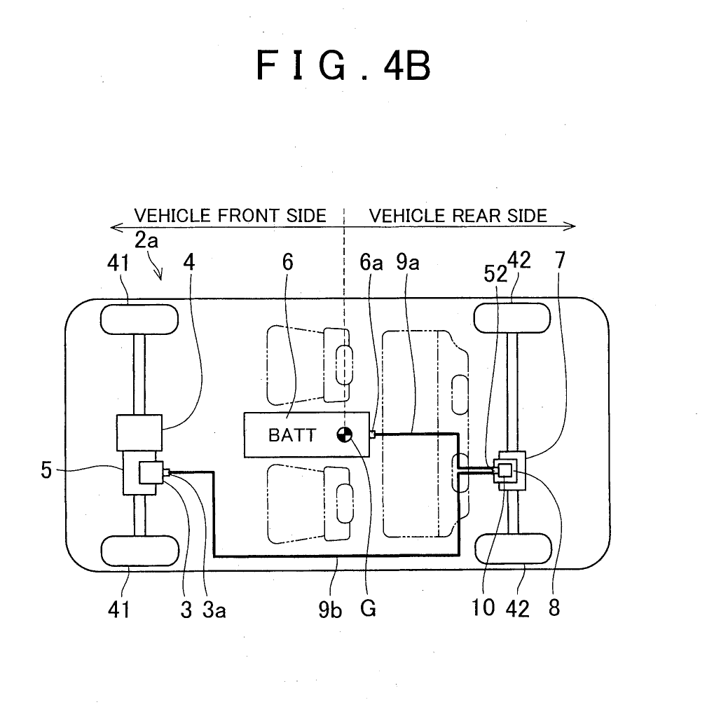

Next, an electrically driven vehicle (a hybrid vehicle 2a) according to the second embodiment of the invention will be described. FIG. 4A is a schematic diagram showing the layout of a battery, inverters, and motors at the time when the hybrid vehicle 2a is viewed laterally, and FIG. 4B is a schematic layout diagram (a planar layout diagram) at the time when the hybrid vehicle 2a is viewed from above. The hybrid vehicle 2a is different from the hybrid vehicle 2 according to the first embodiment of the invention in the mounting position of the battery 6. The hybrid vehicle 2a is identical to the hybrid vehicle 2 according to the first embodiment of the invention in the layout of other devices, namely, the front motor 5, the front inverter 3, the engine 4, the rear motor 7, the rear inverter 8, and the distributor 10. The rear motor 7, the rear inverter 8, and the distributor 10 are coupled to one another to constitute a single unit. The unit can be mounted on the vehicle by a single operation. Besides, a drive system of the hybrid vehicle 2a is also expressed in a block diagram of FIG. 3.

The battery 6 is arranged between the two front seats. In this place, an axle is arranged in a conventional FR vehicle. Therefore, the shape of a passenger space can be made close to the shape of a passenger space of the conventional FR vehicle by arranging the battery in this place. As a result, the user does not feel very uncomfortable.

In the hybrid vehicle 2a according to the second embodiment of the invention as well, the rear inverter 8 is provided with the distributor 10 that distributes the electric power of the battery 6 to the respective inverters. As a result, the hybrid vehicle 2a according to the second embodiment of the invention has the same advantage as the hybrid vehicle 2 according to the first embodiment of the invention.

In the hybrid vehicle 2a according to the second embodiment of the invention, the battery 6 is arranged substantially at the center in the longitudinal direction of the vehicle. The terminal 6a of the battery 6 that is connected to the power cable 9a is located at a rear end of the battery. Thus, the distance between the terminal 6a of the battery 6 and the rear inverter 8 (the distance in the longitudinal direction of the vehicle) is shorter than the distance between the terminal 6a of the battery 6 and the front inverter 3 (the distance in the longitudinal direction of the vehicle). That is, the power cable 9a between the battery 6 and the distributor 10 can be made short.

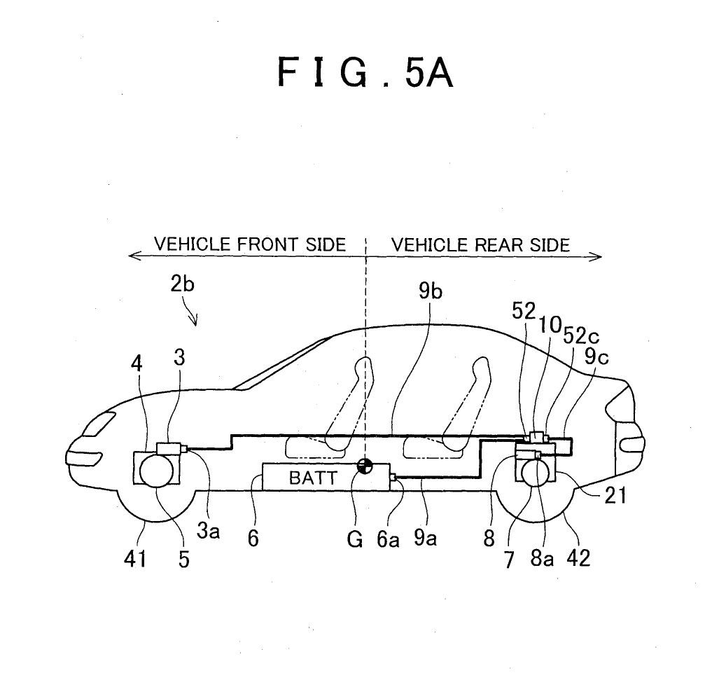

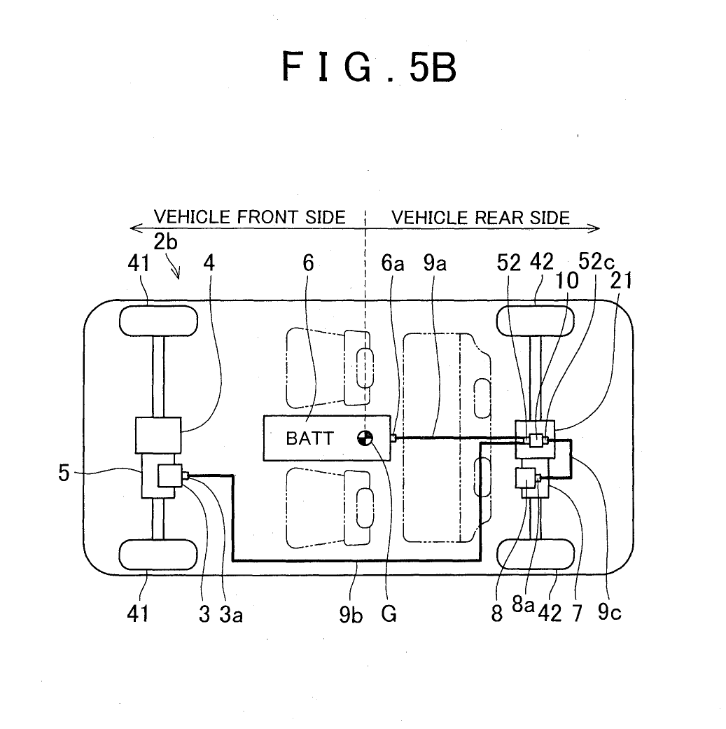

Next, an electrically driven vehicle according to the third embodiment of the invention (a hybrid vehicle 2b) will be described. FIG. 5A is a schematic view showing the layout of a battery, inverters, and motors at the time when the hybrid vehicle 2b is viewed laterally. FIG. 5B is a schematic layout diagram (a planar layout diagram) at the time when the hybrid vehicle 2b is viewed from above. In the hybrid vehicle 2b, the distributor 10 is mounted in a housing of a voltage converter 21 as an optional component instead of being mounted on the rear inverter 8. The hybrid vehicle 2b is identical to the hybrid vehicle 2a according to the second embodiment of the invention in other structural details. The voltage converter 21 is a device that steps down the voltage of the battery 6 to the same voltage as the rated voltage of a household electric appliance (e.g., 100 V). Although not shown in the drawings, an electric power output cable extends from the voltage converter 21, and an outlet of the household electric appliance is connected to a tip of the electric power output cable. The outlet is installed in the vehicle. The household electric appliance can be used in the hybrid vehicle 2b. The voltage converter 21 is mounted on the vehicle together with the rear motor 7 and the rear inverter 8. The voltage converter 21 is equivalent to an example of another device that is attached/removed to/from the vehicle together with the rear inverter 8. The voltage converter 21 is mounted with the distributor 10. The voltage converter 21 is arranged close to the rear inverter 8, and the distributor 10 and the rear inverter 8 are connected to each other by the short power cable 9c. To be more precise, a third terminal 52b of the distributor 10 and a terminal 8a of the rear inverter 8 are connected to each other by the short power cable 9c.

Unlike the hybrid vehicle according to the first or second embodiment of the invention, in the hybrid vehicle 2b according to the third embodiment of the invention, the rear inverter 8 is not mounted with the distributor 10, but a device that is attached/removed to/from the vehicle together with the rear inverter 8 is mounted with the distributor 10. For example, the device is the voltage converter 21. Since the voltage converter 21 is arranged close to the rear inverter 8, the distributor 10 is arranged close to the rear inverter 8. This hybrid vehicle 2b has also the same advantage as the hybrid vehicle according to the first or second embodiment of the invention. It should be noted herein that “the arrangement of the voltage converter 21 close to the rear inverter 8” includes a case where the rear inverter 8 and the voltage converter 21 are arranged behind the position G of the center of gravity of the vehicle with respect to the vehicle in the longitudinal direction of the vehicle.

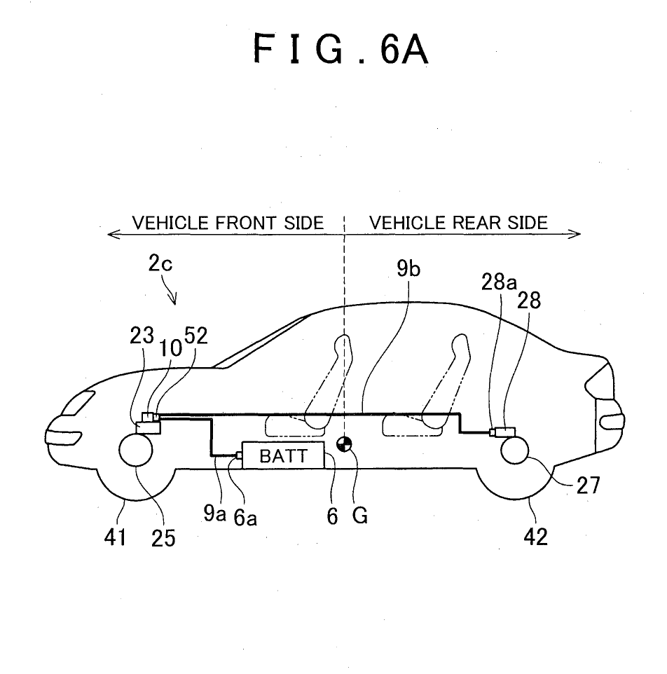

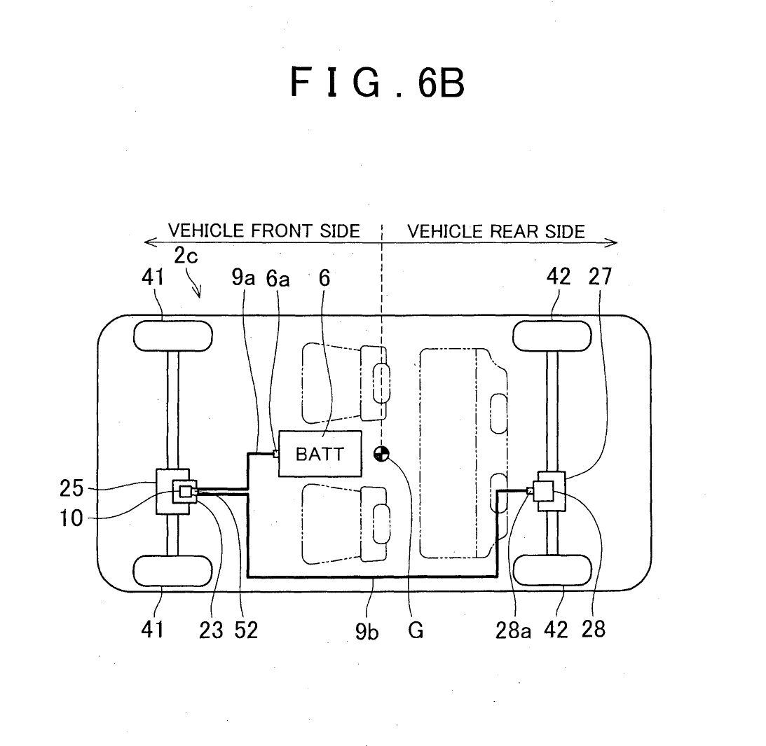

Next, an electrically driven vehicle 2c according to the fourth embodiment of the invention will be described. FIG. 6A is a schematic diagram showing the layout of a battery, inverters, and motors at the time when the electrically driven vehicle 2c is viewed laterally, and FIG. 6B is a schematic layout diagram (a planar layout diagram) at the time when the electrically driven vehicle 2c is viewed from above. The electrically driven vehicle 2c is a so-called pure EV that does not have an engine. Besides, in the electrically driven vehicle 2c, a main motor that outputs a driving force for normal running is mounted in a vehicle rear region, and an auxiliary motor is mounted in a vehicle front region. A front motor 25 is a piece of removable optional equipment that can be mounted later on a two-wheel-drive vehicle whose rear wheels are driven.

In the electrically driven vehicle 2c, a rear motor 27 as a main driving force and a rear inverter 28 that supplies an alternating-current electric power to the rear motor 27 are mounted in the rear region of the vehicle, and the front motor 25 as an auxiliary driving force and a front inverter 23 that supplies an alternating-current electric power to the front motor 25 are mounted in the front region of the vehicle. The rear inverter 28 is fixed to the rear motor 27, and the front inverter 23 is fixed to the front motor 25. As described in the first embodiment of the invention, an attempt to shorten the distance between a motor and an inverter by coupling them to each other contributes toward reducing the loss in electric power transmission. The front inverter 23 may be provided separately from the front motor 25.

In the electrically driven vehicle 2c, the distributor 10 that bifurcates the output electric power of the battery 6 is fixed to a housing of the front inverter 23. The terminal 6a of the battery 6 and the terminal 52 of the distributor 10 are connected to each other by the power cable 9a. This terminal 52 is the first terminal 52a of FIG. 3. The terminal 52 of the distributor 10 and a terminal 28a of the rear inverter 28 are connected to each other by the power cable 9b. This terminal 52 is the second terminal 52b of FIG. 3. The distributor 10 and the front inverter 23 are also connected to each other by a power cable, but the power cable passes through the interiors of the distributor 10 and the front inverter 23 and hence is invisible in FIGS. 6A and 6B.

The electrically driven vehicle 2c is obtained by mounting an electrically driven vehicle originally as a two-wheel-drive vehicle whose rear wheels are driven later with a drive system for front wheels, and thus changing the two-wheel-drive vehicle into a four-wheel-drive vehicle. Specifically, the drive system for front wheels is constituted of the front motor 25 and the front inverter 23. When the drive system for front wheels is mounted, the distributor 10 can also be mounted together with the front inverter 23, so the single operation of mounting the distributor 10 is not required. Besides, with the two-wheel-drive vehicle whose rear wheels are driven, the battery 6 and the rear inverter 28 are connected to each other by a power cable. However, when the two-wheel-drive vehicle is changed into a four-wheel-drive vehicle, there is no need to change the output terminal of the battery 6 and the input terminal of the rear inverter 28. Therefore, the electrically driven vehicle 2c according to the fourth embodiment of the invention also has the same advantage as the hybrid vehicle according to the first, second or third embodiment of the invention.

The battery 6 is mounted between two front seats. The hybrid vehicle according to the fourth embodiment of the invention is identical to the hybrid vehicles according to the second and third embodiments of the invention in the mounting position of the battery 6. However, the battery 6 is installed such that the output terminal 6a thereof is located in a vehicle front region (in front of the position G of the center of gravity). Therefore, the distance from the output terminal 6a of the battery 6 to the distributor 10 (the distance in the longitudinal direction of the vehicle) is shorter than the distance from the output terminal 6a of the battery 6 to the rear inverter 28 (the distance in the longitudinal direction of the vehicle). A total of electric power consumption of the two inverters, namely, the rear inverter and the front inverter flows through the power cable 9a between the battery 6 and the distributor 10, so the loss in electric power transmission can be reduced as the distance therebetween decreases. This also holds true for the first to third embodiments of the invention.

Next, the structure of the distributor 10 will be described with reference to FIGS. 7 and 8. FIG. 7 is a plan view deprived of a cover of the distributor 10, and shows an internal structure of a case 51. The case 51 is made of resin. Metal plates whose internal resistance is smaller than that of a wire cable are used as conductive members inside the case. These metal plates are generally referred to as bus bars. P-bus bars that connect a positive electrode of the battery 6 and positive electrodes of the respective inverters to one another are denoted by reference symbols 53a and 53b respectively. N-bus bars that connect a negative electrode of the battery 6 and negative electrodes of the respective inverters to one another are denoted by reference symbols 54a and 54b respectively. The choke coil 13 is connected between the first P-bus bar 53a and the second P-bus bar 53b. The fuse 12 is connected between the first N-bus bar 54a and the second N-bus bar 54b.

One end of the first P-bus bar 53a and one end of the first N-bus bar 54a are directed toward one lateral face of the case 51. One end of the first P-bus bar 53a and one end of the first N-bus bar 54a are equivalent to the first terminal 52a of the distributor 10. The power cable 9a that extends from the battery 6 is connected to the first terminal 52a. A connector that is provided at a tip of the power cable 9a is denoted by a reference symbol 56a.

The other end of the first P-bus bar 53a and the other end of the first N-bus bar 54a are also directed toward one lateral face of the case 51. The other end of the first p P-bus bar 53a and the other end of the first N-bus bar 54a are equivalent to the second terminal 52b of the distributor 10. The power cable 9b that extends from the front inverter 3 is connected to the second terminal 52b. A connector that is provided at a tip of the power cable 9b is denoted by a reference symbol 56b.

One end of the second P-bus bar 53b and one end of the second N-bus bar 54b are directed toward another lateral face of the case 51. One end of the second P-bus bar 53b and one end of the second N-bus bar 54b are equivalent to a third terminal 52c of the distributor 10. A connector 55 of the power cable 9c that is connected to the rear inverter 8 is combined with the third terminal 52c.

The first terminal 52a and the second terminal 52b of the distributor 10 are provided on the same lateral face of the case 51. The power cables 9a and 9b can be connected to this distributor 10 from the same direction.

FIG. 8 is a view of a distributor according to another example (a distributor 10a). FIG. 8 is a plan view of the distributor 10a deprived of its cover. In FIGS. 7 and 8, like components are denoted by like reference symbols respectively. The distributor 10a is different from the distributor 10 of FIG. 7 in the shape and layout of the first P-bus bar 53a, the second P-bus bar 53b, the first N-bus bar 54a, and the second N-bus bar 54b, but is identical to the distributor 10 of FIG. 7 in function. In the distributor 10a, the first terminal 52a and the second terminal 52b are provided on two parallel lateral faces of the case 51 respectively.

The points to remember about the art described in the embodiments of the invention will be described. In any one of the embodiments of the invention, the distributor 10 has the housing separate from the inverter. The distributor may be built in the inverter. In that case, the distributor may not have any individual housing.

In the fourth embodiment of the invention, the distributor 10 is attached to the housing of the front inverter 23. In an electrically driven vehicle that has a main drive source on rear wheels and an auxiliary drive source (a front motor) on front wheels, a distributor may be attached to another device that is attached/removed together with the front inverter 23 that supplies an electric power to the front motor as an auxiliary drive source.

The distributor 10 is not absolutely required to be attached to the inverter for the auxiliary drive source, but may be attached to a device that is attached/removed to/from the vehicle together with the auxiliary drive source. This example is described in the third embodiment of the invention. Furthermore, it is preferable that the distributor 10 be installed in the vicinity of the inverter for the auxiliary drive source. Thus, during the operation of mounting the auxiliary drive source on the vehicle, the distributor can also be efficiently mounted.

The front motor and the front inverter may be accommodated in a single housing, or may be accommodated in separate housings. By the same token, the rear motor and the rear inverter may be accommodated in a single housing, or may be accommodated in separate housings. Besides, the art disclosed by the present specification is also applicable to an electrically driven vehicle that has three or more motors. The art disclosed by the present specification is also applicable to, for example, an electrically driven vehicle that is equipped with one front motor and two rear motors. In the present specification, for the sake of convenience, “the vehicle front region” and “the vehicle rear region” have been described with respect to the position G of the center of gravity of the vehicle, but the invention is not limited thereto. For example, “the vehicle front region” and “the vehicle rear region” may be defined with respect to the center in the longitudinal direction of the vehicle. “The center in the longitudinal direction of the vehicle” includes the substantial center of a line that links a front end portion of the vehicle and a rear end portion of the vehicle with each other.

Specifically, the battery may be a lithium-ion battery, a fuel battery, a large-capacity capacitor, or other types of batteries.

While the concrete examples of the invention have been described above in detail, these are nothing more than exemplifications, and do not limit the claims. The art set forth in the claims includes various modifications and alterations of the concrete examples exemplified above. The technical elements described in the present specification or the drawings are technically useful alone or in various combinations, and are not limited to the combinations set forth in the claims at the time of the filing of the application. Besides, the art exemplified in the present specification or the drawings can achieve a plurality of objects at the same time, and is technically useful by achieving one of the objects in itself.

What is claimed is:

1. An electrically driven vehicle comprising:
a battery;
a front motor arranged in a front region of the vehicle, the front motor being configured to drive front wheels;
a front inverter arranged in the front region of the vehicle, the front inverter being configured to convert an electric power of the battery into an alternating-current electric power and supply the alternating-current electric power to the front motor;
a rear motor arranged in a rear region of the vehicle, the rear motor being configured to drive rear wheels;
a rear inverter arranged in the rear region of the vehicle, the rear inverter being configured to convert an electric power of the battery into an alternating-current electric power and supply the alternating-current electric power to the rear motor; and
a distributor configured to distribute the electric power of the battery to the front inverter and the rear inverter, one of the rear inverter and another device being provided with the distributor, and the another device being attached to and removed from the vehicle together with the rear inverter.

2. The electrically driven vehicle according to claim 1, wherein
the rear motor is an auxiliary drive source that supplements a driving force of the front motor.

3. The electrically driven vehicle according to claim 2, wherein
a maximum output of the rear motor is smaller than a maximum output of the front motor.

4. The electrically driven vehicle according to claim 2 or 3, further comprising:
a fuse that is arranged in an electric power supply path between the distributor and the rear inverter.

5. The electrically driven vehicle according to claim 2, further comprising:
a choke coil arranged in the electric power supply path between the distributor and the rear inverter, wherein
the front inverter includes:
a step-up circuit configured to step up a voltage of the battery; and
an inverter circuit configured to convert an output of the step-up circuit into an alternating current, and
an input voltage and an output voltage of the rear inverter are equal to the voltage of the battery.

6. The electrically driven vehicle according to claim 1, wherein
the battery is arranged between the front inverter and the rear inverter in a longitudinal direction of the vehicle.

7. The electrically driven vehicle according to claim 1, further comprising:
a first power cable connected to a terminal of the battery and a terminal of the distributor; and
a second power cable connected to the terminal of the distributor and a terminal of the front inverter, wherein
a length of the first power cable is shorter than a length of the second power cable.

8. The electrically driven vehicle according to claim 1, wherein
a distance between the battery and the rear inverter is shorter than a distance between the battery and the front inverter.

9. An electrically driven vehicle comprising:
a battery;
a front motor arranged in a front region of the vehicle, the front motor being configured to drive front wheels;
a front inverter arranged in the front region of the vehicle, the front inverter being configured to convert an electric power of the battery into an alternating-current electric power and supply the alternating-current electric power to the front motor;
a rear motor arranged in a rear region of the vehicle, the rear motor being configured to drive rear wheels;
a rear inverter arranged in the rear region of the vehicle, the rear inverter being configured to convert an electric power of the battery into an alternating-current electric power and supply the alternating-current electric power to the rear motor; and
a distributor configured to distribute the electric power of the battery to the front inverter and the rear inverter, one of the front inverter and another device being provided with the distributor, and the another device being attached to and removed from the vehicle together with the front inverter.
